(19) United States
(12) Patent Application Publication
(10) Pub. No.: US 2007/0235086 A1
(43) Pub. Date: Oct. 11, 2007

(54) FUEL INJECTOR WITH INDUCTIVE HEATER

(75) Inventors: Michael J. Hornby, Williamsburg, VA (US); John F. Nally, Williamsburg, VA (US); Hamid Sayar, Newport News, VA (US); Perry Robert Czimmek, Williamsburg, VA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/689,101

(22) Filed: Mar. 21, 2007

Related U.S. Application Data
(60) Provisional application No. 60/784,199, filed on Mar. 21, 2006.

(51) Int. Cl. F16K 49/00

(52) U.S. Cl. 137/334; 239/135; 251/129.09

(57) ABSTRACT

A fuel injector includes an inductive heater that generates heat inductively in a structure to rapidly heat fuel within the fuel injector. Wires are connected to the inductive heater and are arranged outside of a fuel flow path.

### CROSS REFERENCE TO RELATED APPLICATION

The application claims priority to U.S. Provisional Application No. 60/784,199 which was filed on Mar. 21, 2006.

### BACKGROUND

This application generally relates to a fuel injector for a combustion engine. More particularly, this invention relates to a fuel injector that heats fuel to aid the combustion process.

Combustion engine suppliers continually strive to improve emissions and combustion performance. Once method of improving both emissions and combustion performance includes heating or vaporizing fuel prior to entering the combustion chamber. Starting a combustion engine often results in undesirably high emissions since the engine has not yet attained an optimal operating temperature. Heating the fuel replicates operation of a hot engine, and therefore improves performance. Further, alternative fuels such as ethanol can perform poorly in cold conditions, and therefore also may benefit from pre-heating of fuel.

Various methods of heating fuel at a fuel injector have been employed. Such methods include the use of a ceramic heater, or resistively heated capillary tube within which the fuel passes. In another example, positive temperature coefficient (PTC) heating elements have been used. One disadvantage of these devices is that that they do not heat the fuel quickly or hot enough to have the desired effect at start-up. Another disadvantage of prior art fuel injector heaters is that the wires to the heater are often in the fuel flow path, which is undesirable if the insulation about the wires fails. These wires also create an additional potential fuel leakage path.

What is needed is a fuel injector having a heater that does not create additional fuel leak paths while still providing rapid heating and vaporization of fuel.

### SUMMARY

A fuel injector is provided that includes a actuator configured to move an pole-piece between open and closed positions. The pole-piece provides fuel to a combustion chamber, for example, in the open position when an associated armature is moved by the actuator. An inductive heater is configured to heat fuel within the fuel injector by inducing heat in the pole-piece and/or a valve body, which together provide a fuel flow path in one example. The induced heat rapidly heats the fuel within the fuel injector to improve atomization of fuel expelled from the fuel injector.

Wires within a fuel injector shell are connected to the inductive heater outside of the fuel flow path. In one example, a DC driver and an AC driver respectively provide DC and AC signals to the actuator and inductive heater. A controller communicates with the DC and AC drivers to achieve desired operation of the fuel injector.

Accordingly, the fuel injector provides rapid heating and vaporization of the fuel by induction, which avoids the need for wires within the fuel injector to be arranged in the fuel path.

These and other features can be best understood from the following specification and drawings, the following of which is a brief description.

### BRIEF DESCRIPTION OF THE DRAWINGS

FIG. 1 is a cross-section of an example fuel injector assembly.

FIG. 2 a schematic view of the example fuel injector assembly.

### DETAILED DESCRIPTION OF THE PREFERRED EMBODIMENT

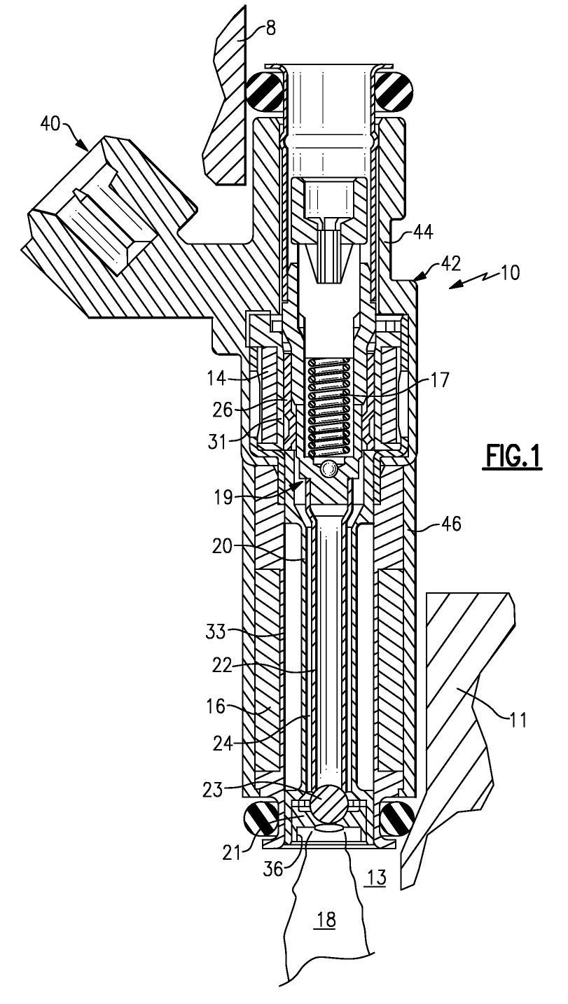

An example fuel injector 10 is shown in FIG. 1. Typically, the fuel injector 10 receives fuel from a fuel rail 8. The fuel injector 10 provides fuel 18 to a combustion chamber 13 of a cylinder head 11, for example, through an outlet 36. Typically, it is desirable to provide well atomized fuel from the outlet 36 to the combustion chamber 13 for more complete combustion and reduced emissions, particularly during cold start conditions.

The fuel injector 10 includes an actuator having a first coil 14 for actuating a pole-piece 19 between open and closed positions. The pole-piece 19 includes an armature 26 interconnected to an armature tube 22. The armature tube 22 supports a ball 23 that is received by a seat 22 when the pole-piece 19 is in a closed position, which is shown in the figures. A return spring 17 biases the ball 23 to the closed position. The ball 23 is spaced from the seat 21 in the open position to provide fuel to the combustion chamber 13.

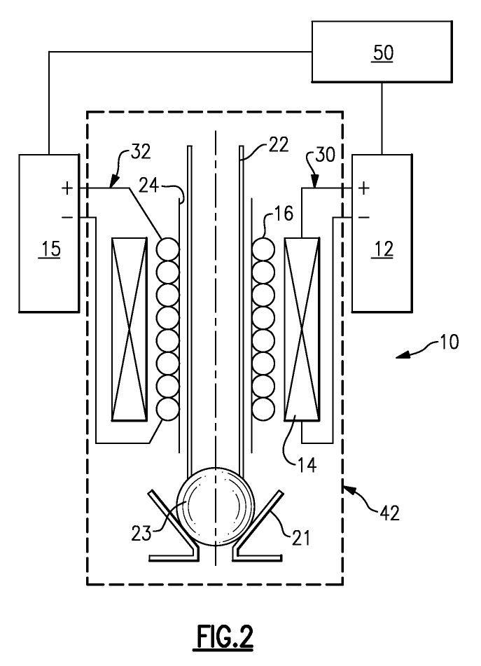

In one example, a DC driver 12 provides a DC signal 30 to the first coil 14, which is shown schematically in FIG. 2. In one example, the DC signal 30 is a square tooth wave modulated between 0 and 14 volts. The DC signal 30 generates a first magnetic field that induces an axial movement of the armature 26, as is known. A first barrier 31 is provided between the armature 26 and the first coil 14 and insulates the first coil 14 from the fuel flow path within the fuel injector 10. Electrical wires (shown in FIG. 2) are connected between the first coil 14 and pins provided by a connector 40 of a shell 42 (FIG. 1). In one example, the shell 42 includes first and second portions 44, 46 that are over-molded plastic arranged about the internal fuel injector components.

A second coil 16 is arranged near the outlet 36 and coaxial with the first coil 14 in the example shown. The second coil 16 heats the fuel within an annular flow path 24 arranged between a valve body 20 and the armature tube 22. In one example, the second coil 16 inductively heats the valve body 20 and/or the armature tube 22 inductively. In the example, a second barrier 33 seals the second coil 16 relative to the internal passages of the fuel injector 10. In one example, the second coil 16 is arranged between the second barrier 33 and the second portion 46. The wires from the second coil 16 to the connector 40 do not extend to the interior passages of the fuel injector carrying fuel, but rather are contained within the shell 42 outside of the annular flow path 24, for example.

Referring to FIG. 2, an AC driver 15 is connected to the second coil 16 to provide an AC signal 32, for example 70 volts at 40 kHz, to the second coil 16. The AC signal 32 produces a time varying and reversing magnetic field that heats up the components within the field. Heat is generated within the valve body 20 and/or armature tube 22 by hysteretic and eddy-current losses by the magnetic field. The amount of heat generated is responsive to the specific resistivity of the material being acted upon and the generation of an alternating flux. The time varying magnetic field produces a flux flow in the surface of the material that alternates direction to generate heat. The higher resistivity of the material, the better the generation of heat responsive to the magnetic field. The heated valve body 20 and/or armature tube 22 rapidly transfers heat to the fuel within the annular flow path 24 to provide a well vaporized fuel exiting the outlet 36 when the pole-piece 19 is opened.

The DC and AC driver 12, 15 and the controller 50 are exterior to the fuel injector 10 in the example shown. The DC and AC drivers 12, 15 can be separate structures and/or software, as shown, or integrated with one another and/or the controller 50.

Although a preferred embodiment has been disclosed, a worker of ordinary skill in this art would recognize that certain modifications would come within the scope of the claims. For that reason, the following claims should be studied to determine their true scope and content.

What is claimed is:

1. A fuel injector assembly comprising:
a structure near a fuel flow path; and
an inductive heater configured to generate a magnetic field for inductively heating the structure in response to a signal.

2. The fuel injector assembly according to claim 1 comprising a pole-piece and an actuator configured to generate a second magnetic field for moving the pole-piece in response to a second signal.

3. The fuel injector assembly according to claim 2 comprising a shell, the actuator and the inductive heater housed within the shell, and wires connected to the actuator and the inductive heater, the wires contained outside the fuel flow path and within the shell.

4. The fuel injector assembly according to claim 1, wherein the structure at least partially provides the fuel flow path.

5. The fuel injector assembly according to claim 4, wherein the pole-piece includes an armature tube arranged within the structure, the structure and the armature tube providing an annular fuel flow path.

6. The fuel injector assembly according to claim 2, wherein the signal is an AC signal and the second signal is a DC signal.

7. The fuel injector assembly according to claim 2, wherein the actuator and inductive heater coaxial with one another and the structure.

8. The fuel injector assembly according to claim 6 comprising first and second drivers respectively communicating with the actuator and the inductive heater, the drivers providing the AC and DC signals.

9. A fuel injector assembly comprising:
a shell housing a pole-piece movable between open and closed positions for selectively blocking a fuel flow path;
an actuator configured to selectively move the pole-piece between the open and closed positions; and
a heater configured to heat fuel within the fuel flow path and having wires connected thereto for providing a heating signal, the wires arranged within the shell and entirely outside the fuel flow path.

10. The fuel injector assembly according to claim 9, wherein the heater is an inductive heater configured to apply a magnetic field to a heat a structure near the fuel flow path in response to the heating signal for heating fuel.
